(19) United States
(12) Patent Application Publication
(10) Pub. No.: US 2019/0122219 A1
(43) Pub. Date: Apr. 25, 2019

(54) SYSTEM AND METHOD FOR REGISTERING AND AUTHORIZING SECONDARY COMPUTING DEVICES FOR CONDUCTING TRANSACTIONS

(71) Applicant: CA, Inc., New York, NY (US)

(72) Inventors: Sharath L. Kumar, Bangalore (IN); Arun Shetty, Bangalore (IN); Badrinath Mohan, Bangalore (IN); Jaimini Ram, Bangalore (IN); Stephen Prasad, Bengaluru (IN)

(73) Assignee: CA, Inc.

(21) Appl. No.: 15/791,535

(22) Filed: Oct. 24, 2017

(51) Int. Cl. G06Q 20/40

(52) U.S. Cl. CPC G06Q 20/4012; G06Q 2220/00

(57) ABSTRACT

According to an embodiment of the present disclosure, a method by a server includes receiving, by the server, a request to conduct a transaction between a merchant and a secondary device associated within an account. A request for a personal identification number (PIN) is transmitted to the secondary computing device. The PIN is received from the secondary computing device. The PIN and transaction information associated with the transaction is forwarded to a primary computing device registered with the account. Authorization to allow the secondary computing device to conduct the transaction is received from the primary computing device. Based on the authorization received from the primary computing device, the transaction between the secondary computing device and a merchant is authorized.

### BACKGROUND

The present disclosure relates to interfaces and, in particular, to a method, apparatus, and executable instructions for registering and authorizing secondary computing devices for conducting transactions.

### SUMMARY

The present disclosure relates to interfaces and, in particular, to a method, apparatus, for registering and authorizing secondary computing devices for conducting transactions associated with a primary user's account.

According to an embodiment of the present disclosure, a method by a server includes receiving, by the server, a request to conduct a transaction between a merchant and a secondary device associated within an account. A request for a personal identification number (PIN) is transmitted to the secondary computing device. The PIN is received from the secondary computing device. The PIN and transaction information associated with the transaction is forwarded to a primary computing device registered with the account. Authorization to allow the secondary computing device to conduct the transaction is received from the primary computing device. Based on the authorization received from the primary computing device, the transaction between the secondary computing device and a merchant is authorized.

According to another embodiment of the present disclosure, a non-transitory, computer-readable storage medium has instructions stored thereon. The instructions are executable by a computing system to cause the computing system to receive a request to conduct a transaction between a merchant and a secondary device associated within an account. A request for a personal identification number (PIN) is transmitted to the secondary computing device. The PIN is received from the secondary computing device. The PIN and transaction information associated with the transaction is forwarded to a primary computing device registered with the account. Authorization to allow the secondary computing device to conduct the transaction is received from the primary computing device. Based on the authorization received from the primary computing device, the transaction between the secondary computing device and a merchant is authorized.

According to another embodiment of the present disclosure, a server includes a memory storing account information for a plurality of accounts and processing circuitry with access to the memory. The processing circuitry is configured to receive a request to conduct a transaction between a merchant and a secondary device associated within an account. A request for a personal identification number (PIN) is transmitted to the secondary computing device. The PIN is received from the secondary computing device. The PIN and transaction information associated with the transaction is forwarded to a primary computing device registered with the account. Authorization to allow the secondary computing device to conduct the transaction is received from the primary computing device. Based on the authorization received from the primary computing device, the transaction between the secondary computing device and a merchant is authorized.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-5, like numerals being used for corresponding parts in the various drawings.

FIG. 1 illustrates an environment for authorization, by a primary computing device associated with an account, of a transaction conducted by a secondary computing device, according to a non-limiting embodiment of the present disclosure.

FIG. 2 illustrates server for authorization, by a primary computing device associated with an account, of a transaction conducted by a secondary computing device, according to a non-limiting embodiment of the present disclosure.

FIG. 3 illustrates a mobile computing device which may include a primary computing device or a secondary computing device, according to non-limiting embodiments.

FIGS. 4A-4B illustrate sequence diagrams depicting example processes for registering a secondary device to conduct transactions authorized by a primary computing device associated with an account, according to a non-limiting embodiment of the present disclosure.

FIG. 5 illustrates a sequence diagram depicting a process for authorization, by a primary computing device associated with an account, of a transaction conducted by a secondary computing device according to a non-limiting embodiment of the present disclosure.

FIG. 6 illustrates a sequence diagram depicting another example process for registering a secondary device to conduct transactions authorized by a primary computing device associated with an account, according to a non-limiting embodiment of the present disclosure.

FIG. 7 illustrates a sequence diagram depicting another example process for authorization, by a primary computing device associated with an account, of a transaction conducted by a secondary computing device according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor and/or processing circuitry of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Users of wireless devices such as mobile phones have access to mobile payment applications that may be used to conduct financial transactions without requiring presentation of a credit or debit card. Such applications are downloaded to the mobile phone or other wireless device and typically require registration of at least one credit or debit card. Thereafter, the user of the mobile phone may use the mobile payment application running on the mobile phone to conduct financial transactions. For example, in a brick and mortar store where the merchant has point of sale (POS) equipment that communicate wirelessly with the mobile phone, the POS equipment may communicate with the application to pay for items purchased. Rather, than swipe a credit or debit card through the card reader of the POS equipment, the buyer may hold the buyer's mobile phone near the POS equipment. The POS equipment may then communicate with the mobile phone to wirelessly request and receive credit or debit card information from the mobile payment application.

As another example, these mobile payment applications may be used for paying for online purchases. Specifically, a user completing a financial transaction using the Internet may select to use the application to complete the financial transaction. Payment may then be authorized and received via the application using stored account information rather than requiring the user to enter the credit card number and other information needed for authorizing the financial transaction.

To prevent fraudulent use of credit and debit cards, mobile payment applications that are used in this manner for conducting financial transactions typically will only accept the information associated with a particular credit card from one user. When a user of a mobile computing device downloads the application and registers a credit or debit card for use, a one-time password (OTP) is sent to the user's mobile computing device. The user must enter the OTP on that device to finalize registration of the card. After a card is registered by a first user, that particular card cannot be registered by another user. If someone tries to register that card for use on another mobile device, the mobile payment system will recognize the credit or debit card as being registered with another account holder and deny registration of the credit or debit card by the second user. As such, all attempts to register a card after the card is registered a first time may be deemed fraudulent.

However, there may be circumstances in which an owner of a credit or debit card (hereinafter, “primary user”) would like to allow other users (hereinafter, “secondary users”) to use the same credit card to conduct financial transactions. For example, a primary card holder may desire to allow a dependent to use a card registered to the primary user to also conduct financial transactions using the mobile payment system. However, as described above, current authentication methods send OTP authorization requests to the same device initiating the registration of the card. While this is permissible in single cardholder transactions, the current evolved market of digital payment systems accommodating secondary cardholders poses some challenges regarding authentication. Specifically, because existing mobile payment systems only allow a credit card number to be registered once, secondary users will be prohibited from using cards that are already registered for use on the primary user's account.

Accordingly, there is a need in the marketplace for mobile payment systems to enable a primary user to authorize secondary users to register a previously registered credit or debit card for use in conducting financial transactions. There is also a need for a mechanism which strengthens security of transactions conducted by a secondary card holder and/or secondary computing device by allowing the primary card holder and/or primary computing device to authorize each transaction. The present disclosure provides, inter alia, a solution to overcome the weaknesses of traditional mobile payment systems. The present disclosure describes, inter alia, a more secure mobile payment system for allowing secondary computing devices to conduct financial transactions at the explicit or implied authorization of a primary user. Embodiments of the present disclosure may address the above problems, and other problems, individually and collectively.

Certain embodiments of the present disclosure may provide one or more technical advantages. For example, certain embodiments make it possible to provision a single credit or debit card on multiple devices. As such, a primary user of an account may authorize one or more secondary users to use a credit or debit card with a mobile payment system without increasing vulnerability to the financial account and the potential for fraud.

Certain embodiments ensure that a primary user or device participates in the authentication of secondary users of secondary computing devices. Stated differently, a primary user is the authentication authority of secondary computing devices and transactions by secondary computing devices. According to certain embodiments, a personal identification number (PIN) may be shared between the primary user and secondary user and/or their respective devices and authorization of transactions may be performed by the primary user or device rather than by the financial institution. As such, a technical advantage may be that authentication infoiiiiation associated with the primary user's account is not stored by an issuing financial institution.

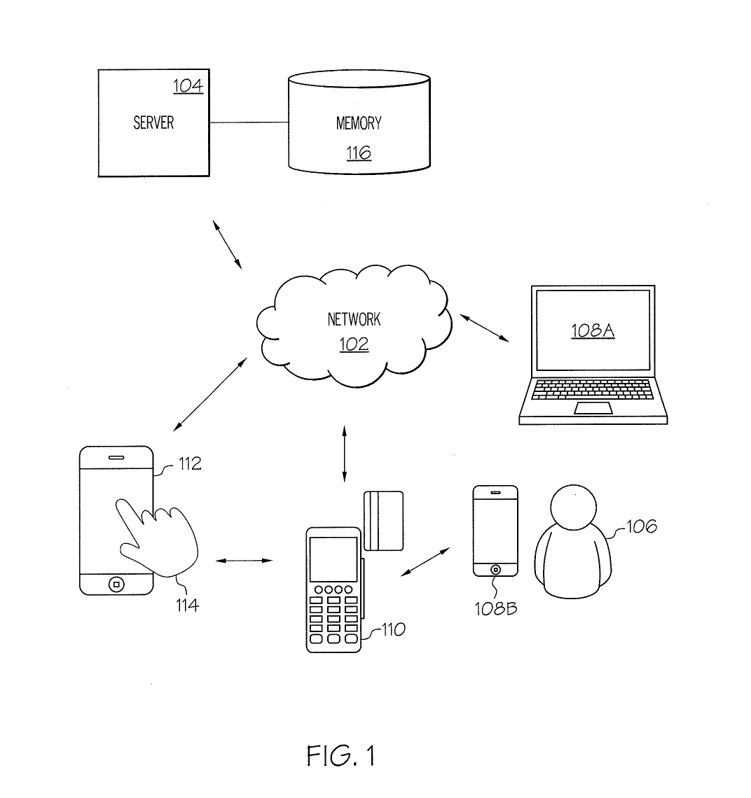

FIG. 1 illustrates an exemplary distributed system 100 in which the subject matter of the disclosure can function. The system 100 generally includes a public network 102 communicatively coupling a server 104 to one or more client devices. In the depicted embodiment, for example, system 100 includes a primary user 106 of one or more primary computing devices 108A-B. A primary user 106 may be a primary card or account holder of a financial account maintained by server 104. As described above, according to certain embodiments, primary user 106 may download a mobile payment application to one or more primary computing devices 108B associated with primary user 106. Primary user 106 may then provision the mobile payment application with credit or debit card account information. The mobile payment application may then be used by the primary user 106 to complete financial transactions.

According to certain embodiments, primary user 106 may also authorize one or more secondary computing devices 112 associated with one or more secondary users 114 to use the same credit or debit card account information with the mobile payment application. For example, when secondary user 114 downloads the mobile payment application to a secondary computing device 112, the secondary user 114 may be prompted to register credit or debit card information. If the secondary user 114 has the primary user's credit or debit card information, the secondary user 114 may enter the information into the secondary computing device 112 to register the card with the mobile payment systems application stored on the secondary computing device 112. However, if server 102 detects, based on the user account information stored in memory 114, that the credit or debit card is already registered to a primary computing device 108A-B associated with primary user 106, server 102 may require authorization from primary user 106 before allowing the secondary user 114 to provision the credit or debit card on the secondary computing device 112. Additionally, according to certain embodiments, the primary user 106 and the secondary user 114 may agree on a PIN number to be used by secondary user 114 when conducting transactions using secondary computing device 112. According to other embodiments, the primary computing device 108A-B and the secondary computing device 112 may be provided with a seed mechanism for generating one-time passwords (OTP) for each transaction. When a transaction is conducted, secondary computing device 112 may send an OTP to the primary computing device 108A-B for authorization. In this manner, primary computing device 108A-B may provide directly determine whether a transaction initiated by the secondary user 114 and/or the secondary computing device 112 should be allowed. As such, an issuer financial institution is not responsible for managing, maintaining, and authenticating the credentials of secondary users and devices.

The network 102 generally refers to any interconnecting system capable of transmitting audio, video, signals, data, messages, or any combination of the preceding. Further, the network 102 may include all, or a portion of a public switched telephone network (PSTN), a public or private network, a local area network (LAN), a metropolitan area network (MAN), a wide area network (WAN), a local, regional, or global communication or computer network such as the Internet, a wired or wireless network, other suitable communication link, or any combination of similar systems.

Primary computing devices 108A-B, secondary computing device 112, and POS equipment 110 may communicate with server 104 via network 102, which may include any number of subnetworks. Network 102 may transmit information in packet flows in one embodiment. A packet flow includes one or more packets sent from a source to a destination. A packet may comprise a bundle of data organized in a specific way for transmission, and a frame may comprise the payload of one or more packets organized in a specific way for transmission. A packet-based communication protocol, such as Internet Protocol (IP), may be used to communicate the packet flows.

A packet flow may be identified in any suitable manner. As an example, a packet flow may be identified by a packet identifier giving the source and destination of the packet flow. A source may be given by an address, such as the IP address, port, or both. Similarly, a destination may be given by an address, such as the IP address, port, or both.

According to certain embodiments, network 102 may utilize protocols and technologies to transmit information. Example protocols and technologies include those described by the Institute of Electrical and Electronics Engineers, Inc. (IEEE) 802.xx standards, such as 802.11, 802.16, or WiMAX standards, the International Telecommunications Union (ITU-T) standards, the European Telecommunications Institute (ETSI) standards, Internet Engineering Task Force (IETF) standards, the third generation partnership project (3GPP) standards, or other standards.

According to certain embodiments, server 104 may include a file server, a domain name server, a proxy server, a web server, a computer workstation, or any other device providing access to enterprise network 110. Further, the server 104 may use any appropriate operating system, such as MS-DOS®, MAC-OS®, WINDOWS®, UNIX®, or any other operating system currently in existence or developed in the future.

According to certain embodiments, server 104 operates as a transaction server and maintains account information in memory 114. The account information may be used in the authorization of primary users and/or secondary users and the completion of financial transactions by such users. According to certain embodiments, memory 114 may include storage media, such as hard disk drives, volatile or non-volatile memory, optical disk storage devices, or any other storage devices, including removable storage devices.

As used here, the term “primary computing device,” “secondary computing device,” “wireless device,” and “computing device” generally refers to any suitable device operable to communicate with the server 104 through the network 102. Primary computing devices 108A-B and secondary computing devices 112 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the server 104 through the network 102. Further, primary computing devices 108A-B and secondary computing devices 112 may employ any known operating systems such as MSDOS®, PC-DOS®, OS-2®, MAC-OS®, or any other appropriate operating systems.

In particular embodiments of the invention, communications between primary computing devices 108A-B and secondary computing devices 112 and transaction server 104 may be effected according to one or more secure wireless communication protocols or WLAN protocols, such as portions or all of the Wired Equivalent Privacy (WEP) protocol, the Robust Security Network (RSN) associated with the IEEE 802.11 protocol, the IEEE 802.1x protocol, the Advanced Encryption Standard (AED), the Temporal Key Integrity Protocol (TKIP), Extensible Authentication Protocol over LAN (EAPOL) algorithms or protocols (such as EAP-TTLS, PEAP, or CISCO' s LEAP or EAP-FAST protocols, for example), WiFi Protected Access (WPA) protocol, WiFi Protected Access Pre-shared key (WPA-PSK) protocol, WiFi Protected Access Version 2 (WPA2) protocol, or WiFi Protected Access Version 2 Pre-shred key (WPA2-PSK) protocol, for example.

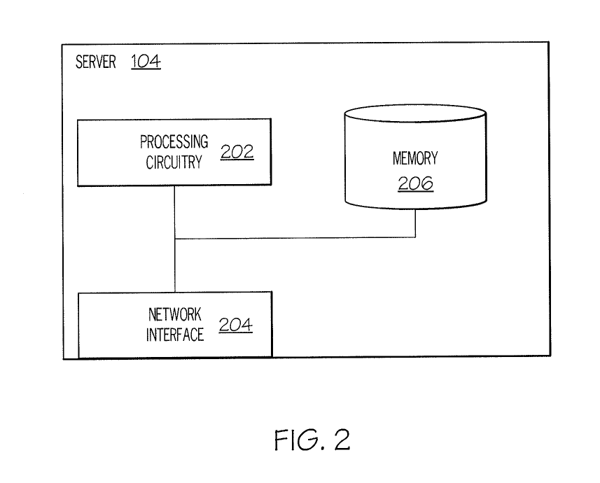

FIG. 2 illustrates a server 104 operating as a transaction server according to a non-limiting embodiment. As depicted, server 104 includes a processing circuitry 202, a network interface 204, and a system memory 206. The network interface 204 connects server 104 to network 102. The processing circuitry 202 may be utilized for the processing requirements of server 104. In certain embodiments, processing circuitry 202 may be operable to load instructions from a hard disk into memory 206 and execute those instructions.

Network interface 204 may refer to any suitable device capable of receiving an input, sending an output from server 104, performing suitable processing of the input or output or both, communicating with other devices, and so on. For example, the network interface 204 may include appropriate modem hardware, network interface card, and similar devices. Further, the software capabilities of the network interface 204 may include protocol conversion and data processing capabilities, to communicate through a LAN, WAN, or other communication system, allowing server 104 to communicate to other devices. Moreover, the network interface 204 may include one or more ports, conversion software, or both.

Processing circuitry 202 can be any suitable device capable of executing instructions to perform operations for server 104. Processing circuitry 202 may include microprocessors, microcomputers, microcontrollers, digital signal processors, central processing units, processing circuitry, state machines, logic circuitries, and/or any devices that manipulate signals based on operational instructions. For example, processing circuitry 202 may be any central processing unit (CPU), such as the Pentium processor, the Intel Centrino processor, and so on.

Further, the system memory 206 may be any suitable device capable of storing computer-readable data and instructions. For example, the system memory 206 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

According to certain embodiments, memory 206 stores account information, which may include any data generated or received for the completion of financial transactions by primary computing devices 108A-B and secondary computing devices 114. For example, account information may include credit or debit card information including account number, expiration dates, security codes, and other suitable information. Additionally, memory 206 may be used to store transaction related information associated with an account. In one example, transaction infon iation may include a list of transactions that have been authorized or denied. Such information may also include merchant identification information, location information, date information, amount information, requesting user information, or other suitable transaction-specific information, according to certain embodiments.

Although server 104 is depicted as including only a single network interface 204, processing circuitry 202, and memory 206, these items may be present in multiple items, or combined items, as known in the art. It is also recognized that other embodiments may include the placement of one or more of these components elsewhere in server 104.

According to certain embodiments, server 104 may provide mobile payment application for provisioning on primary computing devices 108A-B and secondary computing devices 112. For example and as described above, when setting up the mobile payment application on a primary computing device 108A-B, primary user 106 may first register a credit or debit card for use with the mobile payment application. According to certain embodiments, registering the credit or debit card may include entering the credit or debit card account number, expiration date, security code, and any other information associated with the credit or debit card.

As discussed above, to authenticate and register the account, server 104 may send a one-time password (OTP) to the primary computing device 108A-B on which the credit or debit card is being registered. For example, if primary user 106 downloads the mobile payment application to computing device 108B, server 104 sends an OTP to computing device 108B. The mobile payment application may then request that primary user 106 enter the OTP into computing device 108B to authenticate primary user 106 and complete the registration of the credit or debit card for use with the mobile payment systems application.

As described above, in certain embodiments, primary user 106 may wish to allow a secondary user of a secondary computing device 112 to also use the same credit or debit card information for conducting financial transactions with the mobile payment application. For example, in a particular embodiment, primary user 106 may be a parent of a dependent child or adult and may wish to allow the dependent to use the primary user's credit or debit card under some or all circumstances. If the dependent (i.e., secondary user) downloads the mobile payment application to a secondary computing device 112, the dependent will then be prompted to register a credit or debit card.

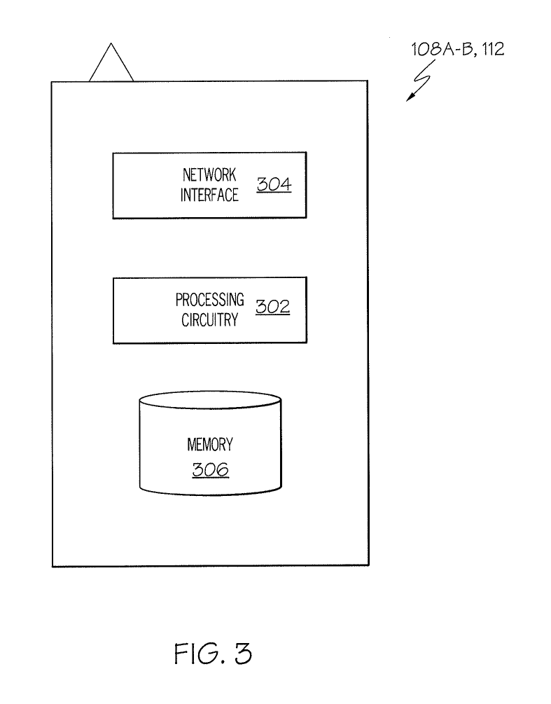

FIG. 3 illustrates a mobile computing device which may include a primary computing device 108A-B or a secondary computing device 112, according to non-limiting embodiments. As depicted, the mobile computing device includes a processing circuitry 302, a network interface 304, and a system memory 306. The network interface 304 connects the mobile computing device to network 102. The processing circuitry 302 may be utilized for the processing requirements of mobile computing device. In certain embodiments, processing circuitry 302 may be operable to load instructions from a hard disk into memory 306 and execute those instructions.

Network interface 304 may refer to any suitable device capable of receiving an input, sending an output from server 104, performing suitable processing of the input or output or both, communicating with other devices, and so on. For example, the network interface 304 may include appropriate modem hardware, network interface card, and similar devices. Further, the software capabilities of the network interface 204 may include protocol conversion and data processing capabilities, to communicate through a LAN, WAN, or other communication system, allowing server 104 to communicate to other devices. Moreover, the network interface 304 may include one or more ports, conversion software, or both.

Processing circuitry 302 can be any suitable device capable of executing instructions to perform operations for the mobile computing device. Processing circuitry 302 may include microprocessors, microcomputers, microcontrollers, digital signal processors, central processing units, processing circuitry, state machines, logic circuitries, and/or any devices that manipulate signals based on operational instructions. For example, processing circuitry 302 may be any central processing unit (CPU), such as the Pentium processor, the Intel Centrino processor, and so on.

Further, the system memory 306 may be any suitable device capable of storing computer-readable data and instructions. For example, the system memory 306 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

According to certain embodiments, memory 306 stores an application for conducting transactions associated with an account. Additionally, memory 306 may store any data generated or received for the completion of financial transactions by primary computing devices 108A-B and secondary computing devices 112. For example, account information may include credit or debit card information including account number, expiration dates, security codes, and other suitable information. Additionally, according to certain embodiments described in more detail below, memory 306 may store data related to a PIN that may be used by a primary computing device 108A-B when determining whether to authorize a transaction initiated by a secondary computing device 112. Additionally or alternatively, memory 306 may store a seed for generating an OTP which may be used to verify the identity of a secondary computing device 112 or the user 114 thereof.

Although the mobile computing device depicted in FIG. 3 is shown as including only a single network interface 304, processing circuitry 302, and memory 306, these items may be present in multiple items, or combined items, as known in the art. It is also recognized that other embodiments may include the placement of one or more of these components elsewhere in the mobile computing device.

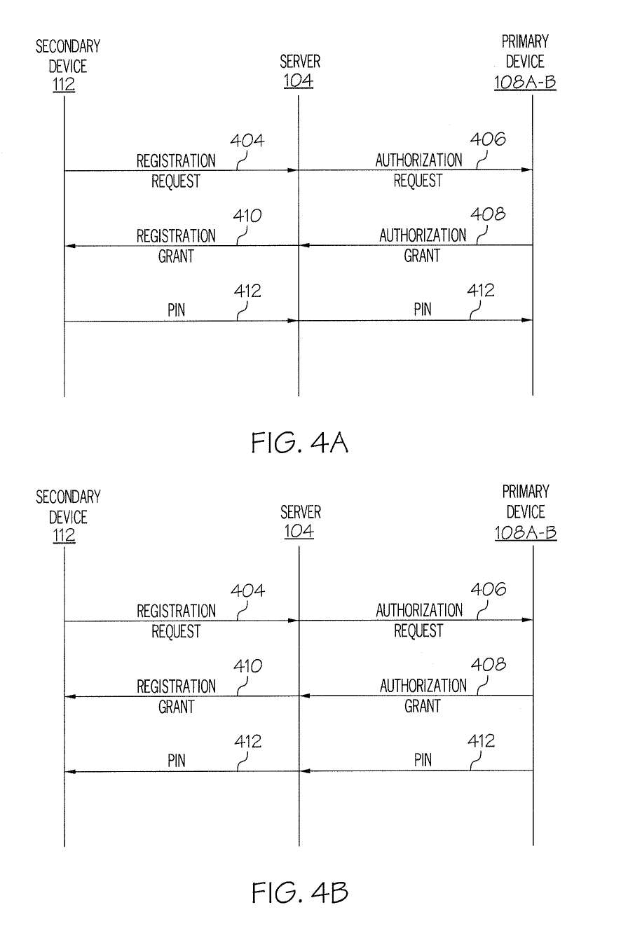

FIGS. 4A-4B illustrate sequence diagrams depicting example processes for registering a secondary computing device 112 to conduct transactions authorized by a primary computing device 108A-B associated with an account, according to non-limiting embodiments of the present disclosure. Specifically, FIG. 4A depicts an example process wherein a secondary user 114 of secondary computing device 112 selects a PIN to be used in conducting transactions.

As depicted, the sequence diagram of FIG. 4A begins when a secondary computing device 112 sends a request 402 to be registered to conduct transactions associated with an account. The registration request 402 may be received by server 104, which may comprise a transaction server associated with the issuer of the account. According to certain embodiments, the request may be generated by an application running on the secondary computing device 112.

According to certain embodiments, server 104 may determine that a primary computing device 108A-B is already registered as a first authorized computing device for conducting transactions associated with the account. As such, server 104 may transmit an authorization request 406, to the primary computing device 108A-B, to authorize the secondary computing device as a second authorized device for conducting transactions associated with the account. For example, server 104 may send an authorization request to the primary user's mobile phone 108B, in a particular embodiment.

According to certain embodiments, authorization request 402 may comprise a pop-up notification that appears on the screen of one or more primary computing devices 108A-B. Specifically, for example, authorization request 402 may request primary user 106 to enter an authorization code to add the secondary user of secondary computing device 112 to the primary user's account and, thus, allowing secondary computing device 112 to be used to conduct financial transactions using the primary user's credit or debit card. In a particular embodiment, the authorization code may include an OTP that is also provided to primary computing device 108A-B. The OTP may be provided on graphic user interface screen or may be provided as a separate pop-up that appears on the screen of primary computing device 108A-B separately from authorization request 402. In the depicted embodiment, primary user 106 may be requested to enter the provided authorization code to authorize secondary user 114 of secondary computing device 112 to conduct transactions.

An authorization grant 408 may then be sent from primary computing device 108A-B to server 104. The authorization grant 408 may give permission to server 104 to register secondary computing device 112 as the second authorized device. As described above, the permission may be received as the OTP entered into the primary computing device 108A-B by primary user 106, according to a particular embodiment. Server 104 then registers secondary computing device 112 to conduct transactions associated with the account. According to certain embodiments, a registration grant 410 may be sent to secondary computing device 112 to notify a user 114 of secondary computing device 112 that registration has been performed.

According to certain embodiments, the registration grant 410 may request user 114 of secondary computing device 112 to select and enter a PIN to be used in conducting transactions associated with the account. In particular embodiments, the PIN may include a string of numerals, alphabetic characters, special characters, or a combination thereof. In particular embodiments, the PIN must meet certain requirements before the PIN will be accepted. For example, according to certain embodiments, it may be required that the PIN include eight characters that must include at least one capital letter, at least one number, and at least one special character. In the depicted embodiment of FIG. 4A, the selected PIN 412 is transmitted from secondary computing device 112 to server 104. Server 104 then forwards PIN 412 to primary computing device 108A-B. Thereafter, primary computing device 108A-B may use the PIN 412 to authorize financial transactions initiated by secondary computing device 112.

FIG. 4B depicts a similar example process for registering secondary computing device 112 to conduct transactions associated with the account of a primary user 106 of a primary computing device 108A-B. However, in FIG. 4B, the primary user 106 of primary computing device 108A-B selects the PIN 412 to be used in conducting transactions. As depicted, primary computing device 108A-B sends PIN 412 to server 104 after device authorization is granted. Thereafter, server 104 forwards PIN 412 to secondary computing device 112 for use in conducting financial transactions with the account.

Various modifications to the example processes depicted in FIGS. 4A-4B are possible. As just one example, though PIN 412 and authorization grant 408 are depicted as being separate in FIG. 4B, it is generally recognized that PIN 412 may be included with or in authorization grant 408, according to certain embodiments. As another example, the transmittal of registration grant 410 may be omitted in certain embodiments. Rather, secondary computing device 112 may infer that registration has been granted when a PIN 412 is either received from primary computing device 108A-B or requested from secondary computing device 112.

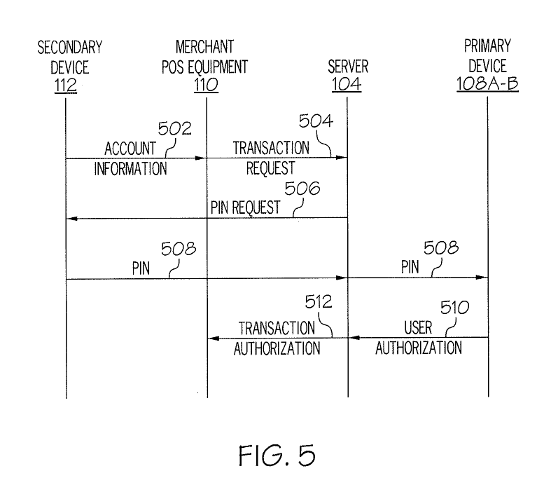

FIG. 5 illustrates a sequence diagram depicting a process for authorization, by primary computing device 108A-C associated with an account, of a transaction conducted by secondary computing device 112 according to a non-limiting embodiment of the present disclosure. As depicted, the sequence diagram of FIG. 5 begins secondary computing device 112 is used to conduct a financial transaction. Financial infollnation 502 is transmitted from secondary computing device 112 to POS equipment 110 when secondary computing device 112 is within close proximity to POS equipment 110. POS equipment 110 or another computing device associated with the merchant then sends a transaction request 504 to server 104. The transaction request 504 may be received by server 104, which may comprise a transaction server associated with the issuer of the account.

According to certain embodiments, server 104 may send a PIN request 506 to secondary computing device 112. After server 104 receives the PIN 508 from secondary computing device 112 or at some point prior to receiving PIN 508, server 104 may determine that primary computing device 108A-B is registered as a primary computing device and/or user associated with the account. Upon receiving PIN 508, server 104 may forward PIN 508 to primary computing device 108A-B for authorization of the transaction. In this manner, primary computing device 108A-B, rather than server 104, is responsible for determining whether secondary computing device 112 is an authorized device for conducting transactions associated with the account. Because server 104 does not maintain credentials for secondary computing device 112, security of the account is improved.

According to certain embodiments, only the PIN may be forwarded to primary computing device 108A-B. Primary computing device 108A-B or a user thereof may then determine if the PIN 508 is recognized. If primary computing device 108A-B or the user 106 of primary computing device 108A-B recognizes PIN 508, primary computing device 108A-B may send user authorization 510 to server 104. Server 104 may then send transaction authorization 512 to POS equipment 110 or another computing device associated with the merchant.

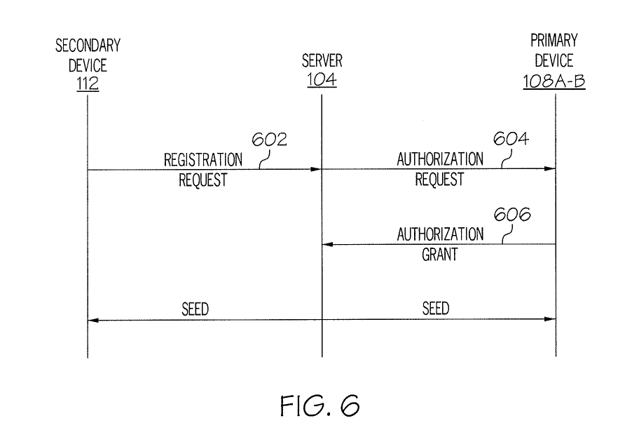

FIG. 6 illustrates a sequence diagram depicting another example process for registering a secondary computing device 112 to conduct transactions authorized by a primary computing device associated with an account, according to a non-limiting embodiment of the present disclosure. As depicted, the sequence begins when secondary computing device 112 sends a request 602 to be registered to conduct transactions associated with an account. The registration request 602 may be received by server 104, which may comprise a transaction server associated with the issuer of the account.

According to certain embodiments, server 104 may determine that a primary computing device 108A-B is already registered as a first authorized computing device for conducting transactions associated with the account. Server 104 may transmit an authorization request 604, to the primary computing device 108A-B, to authorize the secondary computing device 112 as a second authorized device for conducting transactions associated with the account. For example, server 104 may send an authorization request to the primary user's mobile phone 108B, in a particular embodiment.

According to certain embodiments, authorization request 604 may comprise a pop-up notification that appears on the screen of one or more primary computing devices 108A-B. Specifically, for example, authorization request 402 may request primary user 106 to enter an authorization code to add the secondary computing device 112 to the primary user's account and, thus, allowing secondary computing device 112 to be used to conduct financial transactions using the primary user's credit or debit card. Similar to as described above, in a particular embodiment, the authorization code may include an OTP that is also provided to primary computing device 108A-B. The OTP may be provided on graphic user interface screen or may be provided as a separate pop-up that appears on the screen of primary computing device 108A-B separately from authorization request 402. In the depicted embodiment, primary user 106 may be requested to enter the provided authorization code into a graphical user interface to indicate the primary user's permission for allowing secondary computing device 112 to conduct transactions associated with the primary user's account.

An authorization grant 606 may then be sent from primary computing device 108A-B to server 104. The authorization grant 606 may give permission to server 104 to register secondary computing device 112 as the second authorized device. Server 104 then registers secondary computing device 112 to conduct transactions associated with the account.

According to certain embodiments, server 104 may then transmit a seed 608 to each of the primary computing device 108A-B and the secondary computing device 112. The respective devices may use seed 608 to generate an OTP. In a particular embodiment, for example, seed 608 may include an EMV OTP-based solution. According to certain embodiments, server 104 may generate only the seed and may have no knowledge of the OTP that is generated or the PINS that are used to de-camouflage the OTP.

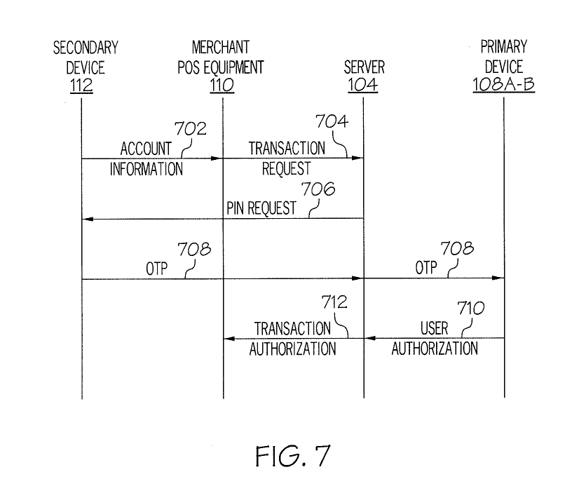

FIG. 7 illustrates a sequence diagram depicting another example process for authorization, by a primary computing device 108A-B associated with an account, of a transaction conducted by a secondary computing device 112 according to a non-limiting embodiment of the present disclosure. Specifically, FIG. 7 depicts authorization by a primary computing device 108A-B of a transaction conducted by a secondary computing device 112 using seed-generated OTPs.

The sequence begins when secondary computing device 112 is used to conduct a financial transaction. According to certain embodiments, account information 702 may be transmitted from secondary computing device 112 to POS equipment 110 when secondary computing device 112 is placed within close proximity to POS equipment 110. According to particular embodiments, secondary computing device 112 and POS equipment 110 may communicate using Bluetooth technology. POS equipment 110 or another computing device associated with the merchant then sends a transaction request 704 to server 104. The transaction request 704 may be received by server 104, which may comprise a transaction server associated with the issuer of the account.

According to certain embodiments, server 104 may send a PIN request 706 to secondary computing device 112. Secondary computing device 112 may use the seed provided by server 104 to generate the OTP. According to certain embodiments, the generation of the OTP on the secondary computing device 112 may require a decrypt of the original seed, which can be handled by a completely independent user-defined PIN.

After server 104 receives the OTP 708 from secondary computing device 112, server 104 may determine that secondary computing device 112 is a secondary computing device associated with the account and that primary computing device 108A-B is registered as a primary computing device for the account. Server 104 may then forward OTP 708 to primary computing device 108A-B for authorization of the transaction. Primary computing device 108A-B may then use the seed to generate an OTP and determine if the generated OTP matches the OTP received from second computing device 112. If the OTPs match, primary computing device 108A-B may send user authorization 710 to server 104. Server 104 may then send transaction authorization 712 to POS equipment 110 or another computing device associated with the merchant.

Additional features and modifications may be made to the processes and systems described above. For example, according to certain embodiments, a new passcode may be periodically generated and/or agreed upon by the users of the primary computing device 108A-B and secondary computing device 112. For example, a new passcode may be implemented on a daily, weekly, or monthly basis, according to particular embodiments. Additionally, primary user 106 associated with primary computing device 108A-B may be permitted to revoke a passcode at any time. As such, if the secondary computing device 112 is lost or the security thereof is otherwise compromised, primary user 106 of primary computing device 108A-B may revoke the agreed upon passcode or seed for generating OTPs. Additionally or alternatively, primary user 106 of primary computing device 108A-B may revoke the registration of secondary computing device 112 as an authorized device for conducting transactions on the account.

Additionally, it is described above, with regard to certain embodiments, that a user 106 of primary computing device 108A-B may manually authorize a transaction based on whether the user 106 recognizes the PIN received from the secondary computing device 112. This method of authentication may be considered explicit authorization since the primary user 106 must act on each and every transaction that is initiated by secondary computing device 112.

In other embodiments described above, the primary computing device 108A-B may store the agreed upon passcode or the seed that may be used to automatically generate an OTP when a transaction is requested. In such scenarios, the agreed-upon passcode or the seed-generated OTP may be automatically compared to the passcode received from the secondary computing device 112. This type of authentication may be considered silent authentication since authorization of the transaction may be performed automatically without requiring user interaction and even, in some cases, without user knowledge.

In still other embodiments, primary computing device 108A-B may be configured to automatically authenticate the PIN or OTP received from secondary computing device 108A-B if certain conditions are met. For example, according to certain embodiments, primary computing device 108A-B may automatically authenticate a transaction if the amount requested for the transaction is less than a predefined amount. In a particular embodiment, for example, primary computing device 108A-B may perform silent authentication of the received PIN or seed-generated OTP if the transaction is less than twenty dollars. It is recognized, however, that the amount of twenty dollars is merely provided for example purposes. The amount may be set by primary user 106 of primary computing device 108A-B or, in some instances, by the issuer financial institution associated with the account.

Multiple conditions may be combined when determining whether authentication should be perfomied silently or explicitly. For example, primary computing device 108A-B or an application running thereon may be configured to silently authorize a predefined number of transactions below a predefined amount. Continuing the example described above, assume the predefined amount is twenty dollars. However, primary computing device 108A-B may be configured to require explicit authorization from the user 106 after five transactions even where each of the five transactions is less than the predefined amount. Accordingly, regardless of the amount of the transaction, primary computing device 108A-B may seek explicit authorization from user 106 for the sixth transaction.

According to certain embodiments, a level of risk may be assigned to the transaction based on information associated with the secondary computing device 108A-B or the transaction. For example, if the transaction is requested with a merchant that is outside a preapproved area, the transaction may be categorized as high risk. Similarly, a transaction that is requested by secondary computing device 112 when secondary computing device is outside a home zip code or more than a predefined distance from a home zip code may be categorized as high risk. Likewise, if the amount of the transaction is outside of a usual pattern for transactions by the secondary computing device 112, the transaction may be categorized as high risk. Or, if the number of transactions within a predefined period of time is higher than usual, the transaction may be categorized as high risk. In these and other high risk scenarios, primary computing device 108A-B may be configured to seek explicit authorization by primary user 106. Conversely, primary computing device 108A-B may be configured to silently authorize low risk transactions that meet predefined criteria.

Certain temporal-based restrictions on transactions by secondary computing device 112 may also be used to determine the method of authorization. Specifically, transactions requested within a predefined time range may be categorized as high risk or low risk depending upon the applied rule. For example, a transaction requested between the hours of seven o'clock in the morning and nine o'clock in the evening may be determined to be low risk and may be silently authorized by the application on the primary computing device 108A-B. However, a transaction occurring after nine o'clock in the evening may be determined to be high risk and may require explicit authorization of the transaction by primary user 106 of primary computing device 108A-B.

According to certain other embodiments, primary computing device 108A-B may intelligently modify the restrictions and risk parameters associated with a primary user's account based on prior authorizations of transactions by primary user 106. For example, if primary user 106 explicitly approves a particular financial transaction, server 104 may identify characteristics associated with that transaction which are deemed permissible. In a particular embodiment, for example, server 104 may determine that the purchase of a particular item from a particular store has been authorized. Thereafter, server 104 may not seek authorization from primary user 106 for subsequent requests for purchases for the same item from the same store by a secondary computing device 112. As such, in a particular embodiment, primary computing device 108A-B may modify the rules applied to transaction based on the shopping trends of authorized users and previously authorized transactions. Conversely, where authorization for a purchase is requested by a secondary computing device 112 at a new merchant, new location, or for a new item, primary user 106 may be required to explicitly authorize the transaction.

The secondary computing device 112 and POS equipment 110 may wirelessly communicate such that POS equipment 110 receives payment information from mobile payment systems application. The payment information may include credit or debit card information associated with primary user's 106 account.

At step 502, the payment information is included in an authorization request which is transmitted from POS equipment 110 to an acquirer banking institution 504. At step 506, the authorization request is then forwarded to an issuer banking institution 508.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in a server diagnostic context, but rather that embodiments of the invention may be used in any transaction having a need to monitor information of any type. The specification and the described examples are considered as exemplary only, with the true scope and spirit of the invention indicated by the following claims.

What is claimed is:

1. A method by a server, the method comprising:
receiving a request to conduct a transaction between a merchant and a secondary device associated within an account;
transmitting, to the secondary computing device, a request for a personal identification number (PIN);
receiving, by the server, the PIN from the secondary computing device;
forwarding, to a primary computing device registered with the account, the PIN received from the secondary computing device and transaction information associated with the transaction;
receiving, from the primary computing device, authorization to allow the secondary computing device to conduct the transaction; and
based on the authorization received from the primary computing device, authorizing the transaction between the secondary computing device and a merchant associated with the transaction.

2. The method of claim 1, wherein the request to conduct the transaction is received from a computing device associated with the merchant and the request comprises the transaction information, and the method further comprises:
determining, by the server, that the secondary computing device is authorized to conduct transactions for the account; and
determining, by the server, that the primary computing device is registered with the account.

3. The method of claim 1, further comprising:
prior to receiving the request to conduct the transaction between the secondary computing device and the merchant:
receiving, from the secondary computing device, a request to register to conduct transactions associated with the account;
transmitting, to the secondary computing device, a request to set the PIN for conducting transactions associated with the account;
receiving, from the secondary computing device, the PIN for conducting transactions associated with the account; and
transmitting, to the primary computing device, the PIN received from the secondary computing device for use in authorizing the transaction

4. The method of claim 1, further comprising:
prior to receiving the request to conduct the transaction between the secondary computing device and the merchant:
receiving, from the secondary computing device, a request to register to conduct transactions associated with the account;
transmitting, to the primary computing device, a request to set the PIN for conducting transactions associated with the account;
receiving, from the primary computing device, the PIN for conducting transactions associated with the account; and
transmitting, to the secondary computing device, the PIN received from the secondary computing device for use in authorizing the transaction.

5. The method of claim 1, further comprising:
prior to receiving the request to conduct the transaction between the secondary computing device and the merchant:
receiving, from the secondary computing device, a request to register to conduct transactions associated with the account; and
transmitting, to the primary computing device and the secondary computing device, a seed for generating the PIN for conducting transactions associated with the account.

6. The method of claim 5, wherein:
the PIN comprises a one-time password;
the secondary computing device comprises a mobile computing device; and
receiving the one-time password from the secondary computing device comprises receiving the one-time password from an application running on the mobile computing device.

7. The method of claim 1, wherein:
the secondary computing device comprises a mobile computing device, and
the request for the PIN is transmitted to the secondary computing device in a SMS message to the mobile computing device.

8. The method of claim 1, wherein:
the primary computing device comprises a mobile computing device, and
forwarding the PIN to the primary computing device comprises transmitting the PIN to the primary computing device in a SMS message to the mobile computing device.

9. The method of claim 8, wherein:
receiving the authorization to allow the transaction from the primary computing device comprises receiving the authorization from an application running on the mobile computing device.

10. A non-transitory, computer-readable storage medium having instructions stored thereon, the instructions being executable by a computing system to cause the computing system to:
receive a request to conduct a transaction between a merchant and a secondary device associated within an account;
transmit, to the secondary computing device, a request for a personal identification number (PIN);
receive the PIN from the secondary computing device;
forward, to a primary computing device registered with the account, the PIN received from the secondary computing device and transaction information associated with the transaction;
receive, from the primary computing device, authorization to allow the secondary computing device to conduct the transaction; and
based on the authorization received from the primary computing device, authorize the transaction between the secondary computing device and a merchant associated with the transaction.

11. The non-transitory, computer-readable storage medium of claim 10, wherein the request to conduct the transaction is received from a computing device associated with the merchant and the request comprises the transaction information, and the instructions are further executable by the computing system to cause the computing system to:
determine that the secondary computing device is authorized to conduct transactions for the account; and
determine that the primary computing device is registered with the account.

12. The non-transitory, computer-readable storage medium of claim 10, wherein, prior to receiving the request to conduct the transaction between the secondary computing device and the merchant, the instructions are further executable by the computing system to cause the computing system to:
receive, from the secondary computing device, a request to register to conduct transactions associated with the account;
transmit, to the secondary computing device, a request to set a PIN for conducting transactions associated with the account;
receive, from the secondary computing device, the PIN for conducting transactions associated with the account; and
transmit, to the primary computing device, the PIN received from the secondary computing device for use in authorizing the transaction.

13. The non-transitory, computer-readable storage medium of claim 10, wherein prior to receiving the request to conduct the transaction between the secondary computing device and the merchant, the instructions are further executable by the computing system to cause the computing system to:
receive, from the secondary computing device, a request to register to conduct transactions associated with the account;
transmit, to the primary computing device, a request to set a PIN for conducting transactions associated with the account;
receive, from the primary computing device, the PIN for conducting transactions associated with the account; and
transmit, to the secondary computing device, the PIN received from the secondary computing device for use in authorizing the transaction.

14. The non-transitory, computer-readable storage medium of claim 10, wherein prior to receiving the request to conduct the transaction between the secondary computing device and the merchant, the instructions are further executable by the computing system to cause the computing system to:
receive, from the secondary computing device, a request to register to conduct transactions associated with the account; and
transmit, to the primary computing device and the secondary computing device, a seed for generating a PIN for conducting transactions associated with the account.

15. The non-transitory, computer-readable storage medium of claim 14, wherein:
the PIN comprises a one-time password;
the secondary computing device comprises a mobile computing device; and
receiving the one-time password from the secondary computing device comprises receiving the one-time password from an application running on the mobile computing device.

16. The non-transitory, computer-readable storage medium of claim 10, wherein:
the secondary computing device comprises a mobile computing device, and
the request for the PIN is transmitted to the secondary computing device in a SMS message to the mobile computing device.

17. The non-transitory, computer-readable storage medium of claim 16, wherein:
receiving the PIN from the secondary computing device comprises receiving the PIN from an application running on the mobile computing device.

18. The non-transitory, computer-readable storage medium of claim 10, wherein:
the primary computing device comprises a mobile computing device, and
forwarding the PIN to the primary computing device comprises transmitting the PIN to the primary computing device in a SMS message to the mobile computing device.

19. The non-transitory, computer-readable storage medium of claim 10, wherein:
receiving the authorization to allow the transaction from the primary computing device comprises receiving the authorization from an application running on the mobile computing device.

20. A server comprising:
a memory storing account information for a plurality of accounts; and
processing circuitry with access to the memory, the processing circuitry configured to:
transmit, to the secondary computing device, a request for a personal identification number (PIN);
receive the PIN from the secondary computing device;
forward, to the primary computing device, the PIN received from the secondary computing device and the transaction information received from the computing device associated with the merchant;
receive, from the primary computing device, authorization to allow the secondary computing device to conduct the transaction; and
based on the authorization received from the primary computing device, authorize the transaction between the secondary computing device and the merchant.
